(19) United States
(12) Patent Application Publication
(10) Pub. No.: US 2019/0377461 A1
(43) Pub. Date: Dec. 12, 2019

(54) INTERACTIVE FILE GENERATION AND EXECUTION

(71) Applicant: Pumpi LLC, Dover, DE (US)

(72) Inventors: Sanat Akhanov, Almaty (KZ); Assylkhan Alibayev, Almaty (KZ)

(21) Appl. No.: 16/004,173

(22) Filed: Jun. 8, 2018

(51) Int. Cl. G06F 3/0482; G06F 3/0485

(52) U.S. Cl. CPC G06F 3/0482; G06F 3/0485

(57) ABSTRACT

In some embodiments, a method of interactive file generation and execution may comprise receiving a non-interactive media file, receiving data, and generating, based on the non-interactive media file and the data, an interactive media file comprising one or more executable instructions based on the first data, and optionally an execution engine for enabling a user device to execute the executable instructions. The interactive media file may be encoded in a file format different from the non-interactive media file format. The method may further comprise transmitting the interactive media file to the user device, displaying the interactive media file, detecting the occurrence of a trigger event, and executing at least one executable instruction of the interactive media file based on the trigger event. An execution engine may be used to execute an instruction, and executing an instruction may modify the display of an interactive media file.

### FIELD OF THE DISCLOSURE

The present disclosure relates, in some embodiments, to generating files for user interaction, the input and output files of a generation process, the content of files used for user interaction, and the computing mechanisms by which interactive files may be executed on a computing device.

### BACKGROUND

Files may be generated based on pre-existing information or information provided at the time of file generation. File types may include image files, document files, spreadsheet files, and source code files. Files may be generated based on pre-determined software routines, computer hardware, manual procedures. Files may be transmitted physically (e.g. via an intermedia physical storage device), or electronically (e.g. via a cable). Files may be interacted with through a touchscreen, or mouse and keyboard. Files may be executed based on software applications or software operating systems. Files may be updated by editing their data.

### SUMMARY

The present enclosure includes embodiments of input data for generation of an interactive file, a method of generating an interactive file, interactive file contents, a system for generating and/or executing an interactive file, and one or more computing devices facilitating interaction with an interactive file.

In some embodiments, a method may comprise receiving, using one or more computing device processors, a non-interactive media file encoded in a first file format; receiving, using the one or more computing device processors, first data; generating, using the one or more computing device processors, based on the non-interactive media file and the first data, an interactive media file comprising one or more executable instructions based on the first data, and an execution engine for enabling a user device to execute the executable instructions; wherein the interactive media file is encoded in a second file format different from the first file format; and transmitting, using the one or more computing device processors, the interactive media file to the user device, wherein the user device displays the interactive media file within a display area of the user device or a display associated with the user device, wherein an occurrence of a trigger event causes execution, by a processor of the user device, of at least one executable instruction of the one or more executable instructions of the interactive media file, wherein the processor of the user device uses the execution engine for executing the at least one executable instruction of the one or more executable instructions of the interactive media file, and wherein the execution, by the processor of the user device, of the at least one executable instruction of the one or more executable instructions, causes a display state of the interactive media file to be modified, within the display area of the user device or the display associated with the user device, from a first display state to a second display state.

In some embodiments, the execution engine comprises an application.

In some embodiments, the execution engine comprises data providing instructions for executing the at least one executable instruction of the one or more executable instructions.

In some embodiments, the at least one executable instruction of the one or more executable instructions is executed by an application on the user device.

In some embodiments, the execution engine comprises metadata, and wherein the processor is located either in the user device or remotely from the user device.

In some embodiments, the user device comprises at least one of a desktop computer, a mobile computing device, a mobile phone, a tablet computing device, a watch, a wearable device, a motor vehicle, eyewear, or a headset.

In some embodiments, the method comprises sharing the interactive media file on at least one of a social media platform, an electronic commerce platform, a messaging platform, or a video-based platform.

In some embodiments, the modification of the display state of the interactive media file is based on data received from an interaction server associated with a third-party network.

In some embodiments, the one or more executable instructions, based on the first data and comprised in the interactive media file, are updated or edited after transmission of the interactive media file to the user device.

In some embodiments, the non-interactive media file comprises at least one of a photo, a video, an audio, a substantially real-time media stream, text, or data.

In some embodiments, the interactive media file comprises a partially self-executing interactive media file.

In some embodiments, the second file format is different from the first file format.

In some embodiments, the second file format is the same as the first file format.

In some embodiments, the user device verifies, based on interaction with a remote server, that the interactive media file is an updated version of the interactive media file before execution of the at least one executable instruction of the one or more executable instructions.

In some embodiments, the display state of the interactive media file is modified, within the display area of the user device or the display associated with the user device, from the first display state to the second display state, when the user device is not connected to a network or the Internet.

In some embodiments, contents or a source associated with the first data is based on the non-interactive media file.

In some embodiments, a system comprises one or more computing device processors configured to receive a non-interactive media file encoded in a first file format; receive first data; and generate an interactive media file based on the non-interactive media file and the first data, wherein the interactive media file is encoded in a second file format, and wherein the interactive media file comprises one or more executable instructions based on the first data, and an execution engine for enabling a user device to execute the one or more executable instructions; and transmit the interactive media file to a user device; wherein the user device is configured to display the interactive media file within a display area of the user device or a display associated with the user device, wherein an occurrence of a trigger event causes execution, by a processor, of at least one executable instruction of the one or more executable instructions of the interactive media file, wherein the processor uses the execution engine for executing the at least one executable instruction of the one or more executable instructions of the interactive media file, and wherein the execution, by the processor, of the at least one executable instruction of the one or more executable instructions, causes a display state of the interactive media file to be modified, within the display area of the user device or the display associated with the user device, from a first display state to a second display state.

In some embodiments, the interactive media file further comprises a segmented image.

In some embodiments, the interactive media file further comprises data configured to associate one or more portions of the display area of the user device or the display associated with the user device, or the at least one executable instruction of the one or more executable instructions, with one or more segmented regions of the segmented image.

In some embodiments, the trigger event is configured to occur automatically based on a programmed condition.

### BRIEF DESCRIPTION OF THE DRAWINGS

Some embodiments of the disclosure may be understood by referring, in part, to the present disclosure and the accompanying drawings, wherein:

FIG. 1 illustrates a sequence of steps related to an interactive file according to a specific example embodiment of the disclosure;

FIG. 2 illustrates a computer network related to an interactive file according to a specific example embodiment of the disclosure;

FIG. 3 illustrates a file generation environment according to a specific example embodiment of the disclosure;

FIG. 4 illustrates an interactive file according to a specific example embodiment of the disclosure;

FIG. 5 illustrates a user device according to a specific example embodiment of the disclosure;

FIG. 6 illustrates an interaction service environment according to a specific example embodiment of the disclosure;

FIG. 7 illustrates an interface of a file generation environment according to a specific example embodiment of the disclosure;

FIG. 8A illustrates an application of an interactive file according to a specific example embodiment of the disclosure; and

FIG. 8B illustrates an application of an interactive file according to a specific example embodiment of the disclosure.

### DETAILED DESCRIPTION

The disclosure generally relates to systems and methods for generating and interacting with an interactive file. An interactive file may be generated based on a non-interactive file (e.g. non-interactive media file such as an image file and video file) and additional data (e.g. computer code, conditional instructions, metadata).

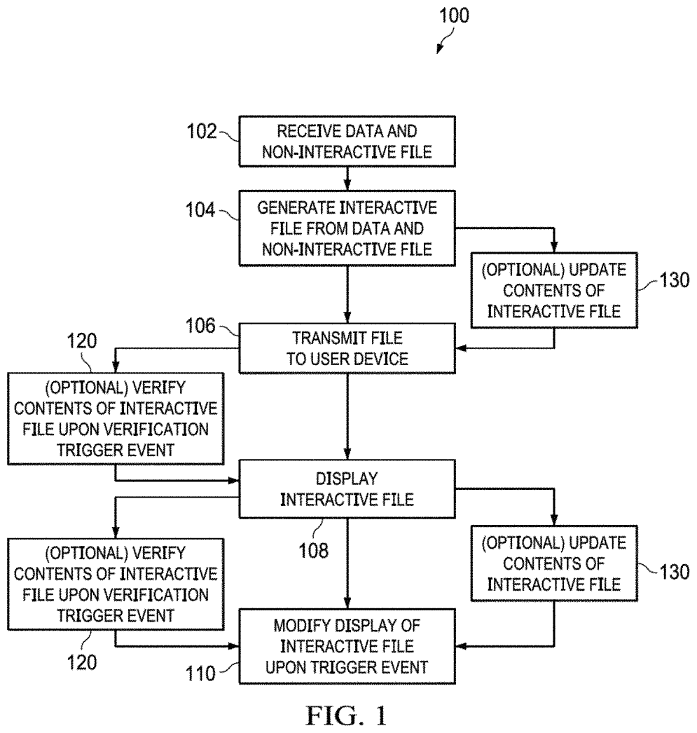

FIG. 1 depicts an example embodiment of an interactive file generation and interaction process 100. As a first step 102, a system (not shown in FIG. 1) may receive a non-interactive file and additional data. For example, a user may provide a non-interactive file (e.g. a typical photo file) by copying a non-interactive file stored on local memory to a memory location accessible and recognized by a computing processor, or alternatively by providing a universal reference identifier (e.g. URL) to a program configured to generate an interactive file. In order to provide data in addition to the non-interactive file, the user may similarly transfer a data file (e.g. text file encoding computer program instructions, such as overlay text on an image upon button press) from local memory, or reference the generation program to a remote resource. Further, data could be provided to the system by facilitation of the generation program or of another program. For instance, a program could prompt the user to provide a certain type of data (e.g. text overlay data, external link data), or to select from a number of pre-determined types of data to provide (e.g. via radio buttons and/or scroll window). The program could also take data of a format entered by the user and convert it to a format suitable to generate an interactive file (e.g. convert provided text into a computer code instruction configured to overlay the text upon clicking the image).

A second step 104 could involve generating an interactive file from the provided non-interactive file and data. For example, from a provided image file and text overlay instruction data, the system could combine the file and data (e.g. via concatenation, embedding of the data within the image file) to produce a resultant interactive file. The interactive file may then be configured to self-modify or facilitate self-modification upon interaction by a user.

After generating an interactive file, the system could perform the step 106 of transmitting the file to a user device, either directly (e.g. automatically upon file creation or upon user request for file transmission) or indirectly (e.g. the system may provide the interactive file to the user in a download for copying to the user device, or send the file to one or more intermediate computing devices before the interactive file reaches the user device). Once the file exists on the user device, the step 108 of displaying the interactive file on the user device could be performed. For instance, an image file could be displayed within a social media application (e.g. occupying only a portion of the screen), or within another image viewer application (e.g. entire screen). Step 108 could also apply for video files, and an analogue of “displaying” for audio files could include speaker generation of a corresponding acoustic waveform.

After display of the interactive file on the user device, the step 110 of modifying the visual display of the interactive file (e.g. overlay text) upon a trigger event (e.g. user clicks on image) could be performed. The step 110 of modifying the visual display upon a trigger event could happen multiple times (e.g. user clicks on different objects within image, thereby causing different text overlays).

Additional, possibly optional, steps 120, 130 may also be performed. For example, the system may perform the step 120 of verifying the contents of the interactive file (e.g. verify contents are up-to-date, not corrupted, and/or secure to run on a user device) upon a verification trigger event (e.g. upon interactive file transmission to user device, display of the interactive file, and/or interaction with the interactive file). Another possibly optional step 130 may include updating the contents of the interactive file. For example, a server (not shown in FIG. 1) storing the up-to-date contents of an interactive file could send updated versions of the interactive file to user devices (e.g. pro-actively, based on a schedule, or in response to a device request, such as a request following a contents verification step 120). Alternatively or in addition, updating the contents of the interactive file could happen upon user interaction with the displayed (or otherwise output) interactive file.

In some embodiments, a non-interactive file may contain content (e.g. bits corresponding to an image or audio output) operable to be output or possibly interacted with via an additional application and/or program, but does not itself contain instructions, programs, software, computer code, etc. operable to be executed. That is, in some embodiments, all interaction with a non-interactive file may be fully facilitated by an external application, server, operating system, program, instruction, etc. For example, a digital photo may be viewable and editable on a computer screen display exclusively due to an external application for viewing and/or editing the digital photo, and the digital photo file may not contain any operation instructions. However, a non-interactive file may contain “passive” metadata (e.g. date, language, color format) which, while not directly executing interactive functionality with the file, may inform an external application facilitating how to interpret and/or process the non-interactive file.

A non-interactive file may serve as a “base file” to be modified and/or used in combination with provided data in order to generate an interactive file. For example, an image file may serve as the provided non-interactive file, upon which textual or segmentation “data” also provided is used for overlaying on and/or interacting with content substantially corresponding to the non-interactive file during an interaction with the derived interactive file.

Non-interactive media files may include photos (e.g. JPEG, JPEG 2000, GIF, PNG, TIFF, BMP, and/or RAW file formats), videos (e.g. MP4, AVI, MPEG-1, MPEG-2, MPEG-4, MOV, OGG, AVCHD, H.264, H.265, MKV, RMVB, and/or WMV9 file formats), textual data (e.g. TXT and/or CSV file formats), audio files (e.g. AAC, MP3, WAV, WMA, DTS, AIFF, ASF, FLAC, ADPCM, DSD, LPCM, and/or OGG file formats), bits, etc. “Media”, as used in “media file”, “non-interactive media file”, or “interactive media file”, may generally refer to any content used for communication. For example, a PDF file could comprise media content, and therefore be considered a media file. In some embodiments, a non-interactive media file may comprise a video stream (e.g. one-way video stream, two-way video stream), real-time video file, audio file, augmented reality session, virtual reality session, gaming session, exercise session, educational session, etc.

A non-interactive media file may or may not be provided in a pre-processed state to facilitate derivation of an interactive media file from the non-interactive file. A non-interactive media file may be annotated with metadata or other information indicating where spatial and/or temporal placement of visual and/or aural modifications are recommended or required to occur. For example, a video file could contain subtitles (e.g. of SRT format sent in a “sidecar” file or directly included in the video file) operable to be conditionally overlaid on the video based on user selection and timing data provided with the subtitles. Additionally the non-interactive media file may be provided with inactive or non-interactive instructions, computer code, or other information operable to render the non-interactive media file interactive upon further processing and/or modification. For example, a non-interactive file could contain instructions in an encrypted and/or non-executable format that are un-encrypted and/or rendered executable within an interactive file based on a generation process using the non-interactive file as an input. Alternatively or in addition, in some embodiments, a non-interactive file and/or non-interactive media file may comprise one or more instructions operable to enable interaction with the non-interactive file and/or non-interactive media file. In some embodiments, a non-interactive file may comprise an interactive file (e.g. for editing and/or adding additional information to).

A file may comprise data and/or data may comprise a file. Information may comprise data and/or data may comprise information. Portions of a file may be stored in one location (e.g. local to the processor performing the generation of an interactive file), remotely (e.g. on a networked device or server to which the processor performing the generation of an interactive file is directed), or both locally and remotely. Alternatively or in addition, in some embodiments portions of a file may be generated in response to instructions provided by the user at the time of the interactive file generation (e.g. user may select among pre-determined image file templates to generate, and/or the interactive file generation processor may also carry out algorithms that generate a media file based on a compressed set of instructions). Further, files may be compressed and/or encoded, e.g. to reduce file size and/or provide security during storage (and/or transmission) of the file.

Data provided in addition to a non-interactive file or files for generation of a may include instruction(s), program(s), computer code, pre-compiled computer code, software function(s), byte code, assembly code, machine code, textual data, purchase information, language information, historical information, social media statistics, address(es), phone number(s), email address(es), contact information, characteristic(s) of an individual (e.g. name, location, contact information), characteristic(s) of an object (e.g. color, model, price, availability, rating), characteristic(s) of data within the non-interactive media file, universal resource identifier (e.g. URL, URN), network information, an interaction policy, etc. In some embodiments, data may not comprise an instruction or information from which an instruction and/or program is derived. In some embodiments, data is generated automatically based on a non-interactive file. For example, an input non-interactive media file (e.g. an image file) may be locally processed (e.g. with an image segmentation algorithm) and/or sent to a third party network for further processing and/or data generation (e.g. associate segments of the image with appropriate objects, merchandise, people, users, location, information, etc.). Data may be generated based on machine learning, neural networks, artificial intelligence, deterministic algorithms, and/or algorithms involving user input.

Data may comprise metadata and/or computer programs Data to be associated with a media file may include textual data (e.g. open captions, closed captions, contact information, location information, price, payment information, URI, URL, images, language selection, image filters, video games, computer code, program, application, file) or other media data (e.g. images, photos, pictures, videos, audio files, artist work product files). The data may be overlaid on the image by default, or may be displayed upon user interaction with the media file (e.g. by clicking on the media file). Computer program data may be executed upon interacting with an interactive media file. Further interaction with the computer program may take place within the display area of a derived interactive file, or at a different location (e.g. portion of the screen not displaying interactive file, or within a different application and/or website).

Data may include a non-interactive file, a non-interactive media file, an interactive file, and/or an interactive media file. For example two non-interactive image files can be provided in order to generate an interactive file that switches between display of the two images upon a button press by a user. Alternatively or in addition, a non-interactive file can be provided with an interactive file in order to augment or further enhance the interactive file, to replace the underlying media content of the interactive file, and/or composite or combine the media content of a provided interactive file with media content of a provided non-interactive file, thereby potentially performing a sort of “update” or “editing” operation.

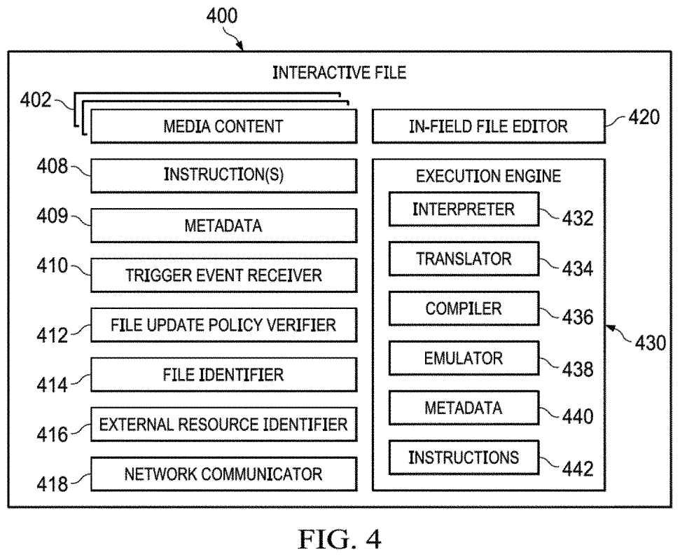

FIG. 4 depicts an example embodiment of an interactive file 400, which may or may not be an interactive media file, interactive application, and/or interactive media application. An interactive file may comprise one or more media content 402 data, instruction(s) 408, metadata 409, a trigger event receiver 410, a file update policy verifier 412, a file identifier 414, an external resource identifier 416, a network communicator 418, an in-field file editor 420, and/or an execution engine 430. An execution engine 430 may further comprise an interpreter 432, translator 434, compiler 436, emulator 438, metadata 440 and/or instructions 442. Some, all, or none of the elements illustrated in FIG. 4 may be comprised in an interactive file 400.

Media content 402 of an interactive file 400 may contain content similar and/or identical to that of a specific non-interactive file or non-interactive files in general. For example, an interactive file 400 may comprise image and/or video content, which may be substantially similar to, identical to, and/or completely different from the media content of a “source” non-interactive file. For example, the media content 402 of an interactive file 400 may be generated to complement the media content of a source non-interactive file (e.g. if an image of a dog is input as a non-interactive media file, and image of a cat may be generated as at least a portion of the media content of an interactive file). Alternatively or in addition, the media content 402 of an interactive file 400, if present, may be generated randomly (e.g. based on the “seed” media content of a non-interactive file).

An interactive file 400 may contain at least one instruction 408 configurable and/or operable to cause an action to take place upon detection of a user interaction. One or more instructions 408, or other information comprised in “data” used to generate an interactive file 400, may be embedded, “sewn”, and/or “stitched into” the interactive file 400 (e.g. when adding data to non-interactive file to generate interactive file). Alternatively or in addition, data may be considered to augment or “pump” a non-interactive file, thereby generating an interactive file. Instructions 408 may be encoded in a computer processor language and/or data format such as bytecode, portable code, p-code, object code, native code, machine code, microcode, binary code, hex code, pre-compiled code, source code, object code, plaintext, wrapped code, etc. Additionally or alternatively, instructions 408 can be comprised in a “package” of information and/or instructions, for example in a DEB format, RPM format, and/or other format operable and/or configured to interact with a standardized software interface (e.g. upon execution of an “apt” or “yum” command). An interactive file 400 may also comprise metadata 409.

In some embodiments, an interactive file 400 may be an executable file (e.g. file format EXE or otherwise executable via zero or more intermediate steps). Executable files may at least comprise an executable instruction, function, and/or program, but may also comprise non-executable data (e.g. media data, metadata) that may be read in the same way that a non-executable file may be read.

Media content 402, instruction(s) 408, and/or other data of an interactive file 400 may be stored locally (e.g. within the interactive file itself) and/or remotely (e.g. on a backend server that serves the data upon request). For data stored within an interactive file, the file format of the interactive file may comprise a concatenation of a standard file format representing a visually displayed portion of the media file (e.g. JPEG) and an additional portion representing metadata and/or executable computer code (e.g. provided by “data” used to generate the interactive file). Alternatively or additionally, both the visually-displayed (e.g. image) data or other media content data from a non-interactive file, and metadata and/or program data from “data” used to generate an interactive file, may be interleaved and/or compressed together. Also, instructions 408 and/or other data may be embedded within media content and/or concatenated onto a media file format (e.g. JPEG), and therefore may result in a new file format (e.g. PJPEG, PGPU, or PGPI). For data stored remotely, a copy of at least a portion of an interactive file (and/or the source material and instructions to generate at least a portion of an interactive file) may be stored in a networked server database and associated with a key and/or other identifier in order to map the stored content to a partial or full interactive media file on a user device.

One or more instructions 408 may be used to display and/or modify the display of media content 402 on a user device and/or screen, e.g. during a user interaction session. For example, visual display of media content 402 such as an image may be modified by compositing and/or overlaying additional media and/or visual content on the originally displayed media content 402. Updates of a “sensory” (e.g. visual for images, aural for audio files) output may include overlays, transaction confirmation, notification of trigger event occurrence, and/or registration of trigger event. In some embodiments, modification of an interactive file and/or the output of an interactive file may happen in real-time (e.g. an image-segmentation algorithm segments different images from a video stream as they arrive and/or are displayed by a screen of the user device).

Instructions 408 and/or data of an interactive file may include text, price, payment, URL, location, geolocation, image, language selection, image filter, flash program, and/or other information. This information may or may not be partially and/or fully derived with “data” provided during interactive file generation. An instruction 408 may generally be any information and/or data that describes how a computing device and/or processor can and/or should modify output and/or displayed media content on a user device and/or screen before, during, and/or after a user interaction session. For example, an instruction 408 may instruct a user device and/or another possibly remote computing device to apply an image filter to an image output, and/or change the displayed image to another image that may or may not be comprised in the media content 402 of the interactive file 400. Alternatively or additionally, an instruction 408 may contain information describing an operation to be performed that does not update a sensory output (e.g. visual display) of media content (e.g. an image file). For example, an instruction 408 may instruct a user device and/or a remote server to perform a search (e.g. textual and/or visual), update operation, security verification, and/or online purchase. However, in some embodiments, an instruction 408 may not contain information and/or data operable to be executed on a computing processor and/or device, or at least not operable to be executed without further interpretation and/or transformation.

An instruction 408 and/or media content 402 of an interactive file 400 may or may not be executable. Executable may mean that the information and/or data is operable and/or configured to be directly carried out on the computing device containing the interactive file 400. For example, executable information may be encoded in a format recognizable by computing hardware and/or software after zero or more translation, interpretation, compilation, and/or transformation procedures. However, executable information may alternatively or additionally imply that the information is to be used as seed or source material to a procedure, process, and/or algorithm which outputs different information (and/or information encoded in a different format) that better facilitates execution of the information (e.g. if it contains instructions) on a computing device.

An interactive file 400 may contain one or more programs, e.g. in the form of media content 402, one or more instructions 408, and/or other data within the interactive file 400 and/or referenced by the interactive file 400 (e.g. in the form of a URI, URL, IP address, or other identifier to a remote resource). A program may be a partial or full set of instructions operable to autonomously and/or semi-autonomously direct activity of a computer processor. A program may comprise algorithms, libraries, references to external computing resources (e.g. dynamic and/or dynamically linked libraries), and/or metadata. An interactive file 400 may also contain one or more applications. A program may comprise an application and/or software application, and/or an application may comprise a program. An interactive file 400 may comprise means (e.g. one or more instructions 408 and/or a program) operable to determine whether or not the interactive file is compatible to be run on a certain software application and/or hardware device, and conditionally open in an appropriate software and/or hardware environment based on that information. Therefore, the interactive file may or may not comprise “self-determination” of operability, and/or may rely on external software and/or hardware to perform such a determination of operability and/or compatibility.

An interactive file 400 may further comprise a trigger event receiver 410. A trigger event receiver may be configured to detect and/or receive notification of the occurrence of one or more trigger events that took place within and/or on the user device, and/or at a remote location (e.g. a backend server). The trigger event receiver 410 may be configured to interface with one or more hardware and/or software interfaces of the computing device on which an interactive file 400 is located. The trigger event receiver 410 may interpret, process, and/or pass on trigger event information and/or trigger event occurrence information. For example, the trigger event receiver 410 may detect and/or receive an indication that a user has clicked on displayed media content 402, which may result one or more instructions 408 being performed. In some embodiments, an interactive file 400 may communicate with one or more other interactive files (e.g. in a gaming application, communication application, and/or network statistical aggregation application).

An interactive file 400 may also comprise a file update policy verifier 412. The file update policy verifier 412 may verify that the interactive file has been appropriately updated according to a policy stored within the interactive file 400 and/or at another location. For example, the file update policy verifier 412 may verify that the interactive file 400 contents are not “stale” or out-of-date, and request verification of the interactive file 400 contents.

An interactive file 400 may comprise a file identifier 414. A file identifier 414 may be generated for and/or inherited by an interactive file 400 before, during, and/or after generation. A file identifier 414 may be used to identify an interactive file 400 and/or associate an interaction, content, instruction(s), and/or other data with an interactive file 400. For example, during interaction with an interactive file 400 on a user device, a user device processor may request that all or some of an interactive file 400 is loaded, updated, verified, etc. based at least in on an identifier 414. A file identifier 400 could alternatively or additionally be stored on an interaction service environment and/or interaction server (not shown in FIG. 4) in order to determine the relevant content and/or other data to serve, process, receive, and/or send to a user device.

Further, an interactive file 400 may comprise an external resource identifier 416 operable and/or configured to identify an external resource for reference, redirection, polling, and/or information gathering by the interactive file 400 and/or by an application running the interactive file 400. For example, an external resource identifier 416 may comprise an interaction server IP address, search database IP address, online retailer URL, payment processor identification information, backup storage locator, GPS poller, another interactive file identifier 414 (e.g. in order to provide for communication and/or interactivity between users interacting with two or more interactive file), and/or an interactive file generation environment URI (e.g. in order to request information from the interactive file generation environment, such as when the interactive file 400 was generated, whether the interactive file 400 is expired, whether a sufficient fee was paid to generate and/or maintain activity of the interactive file 400, and/or what source content was used generate the interactive file 400). An interactive file 400 may also comprise a network communicator 418, which may be operable and/or configured to communicate with an external resource (e.g. a remote server) and/or a local resource (e.g. a LAN device, file in another directory). Additionally or alternatively, the network communicator 418 may be used to retrieve, send, communicate with, and/or interact with an external resource identified by an external resource identifier 416.

An interactive file 400 may comprise an in-field file editor 420. As opposed to an initial generation process of an interactive file 400 (e.g. within and/or by interaction with a file generation environment), an in-field file editor 420 may allow for editing, updating, modifying, adding content to, deleting content from, and/or transforming content of an interactive file 400 during user interaction, execution by a user application, and/or from software and/or hardware not currently displaying the interactive file 400 (e.g. another application operable to edit an interactive file and/or a remote server operable to modify and send updates for an interactive file 400).

An interactive file may comprise an execution engine 430 for executing one or more instructions located on the within the interactive 400 (e.g. instructions 408), referenced by the interactive file 400, and/or invoked by an application supporting displaying, outputting, editing, and/or interacting with an interactive file 400. Execution engine could be replaced and/or supplemented by execution enabler. An execution enabler may comprise at least some of the functionality of an execution engine and/or additional functionality operable and/or configured to execute, assist in executing, and/or enable execution of one or more instructions 408 of an interactive file 400. For example, an execution enabler may comprise a decryption code, authentication information, and/or a passcode. In some embodiments execution engine and execution enabler are the same. An execution enabler and/or execution engine may comprise one instruction, zero instructions, metadata, or none of these. An execution engine 430 may comprise a translation instruction and/or a variable for input to another function. In some embodiments, an interactive file 400 may be “self-executing” (e.g. due to an execution engine 430, metadata 409, or instruction(s) 408), such that the interactive file 400 may execute substantially or entirely without assistance from other software applications, libraries, and/or plugins.

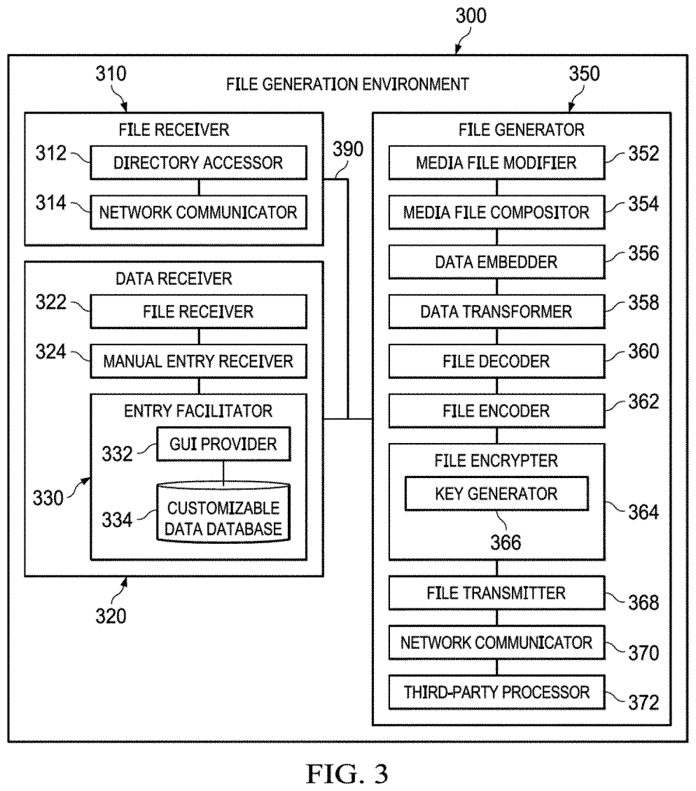

FIG. 3 illustrates an example embodiment of a file generation environment 300 for generating an interactive file. The file generation environment 300 may or may not be an interactive file environment. Embodiments of a file generation environment 300 may use some, all, or none of the elements illustrated in FIG. 3, and/or may use additional elements not illustrated in FIG. 3. An interactive file may be generated based on one or more non-interactive files, and/or one or more portions of data. Generation may also be referred to as “pumping”, embedding, augmenting, and/or synthesizing. A file generation environment 300 may comprise a file receiver 310, a data receiver 320, a file generator 350, and a connective inter-communication means 390 (e.g. wired bus and/or wireless communication link).

A file receiver 310 may further comprise a directory accessor 312 and a network communicator 314. A directory accessor may automatically or semi-automatically (e.g. upon input of a user command) retrieve a file (e.g. a non-interactive file and/or media file) and/or other data to be used in the generation of a file, such as an interactive file. A network communicator 314 may or may not be used to automatically or semi-automatically (e.g. upon input of a user command) locate, identify, collect, and/or receive file(s) and/or data not local to the file generation environment 300 (e.g. a file accessible at a provided URL, or on a server with a provided IP address and/or authentication information). Receive may generally refer to a file generation environment 300 coming into direct (e.g. local storage) and/or indirect (e.g. reference to containing storage) possession of information (e.g. files, data, non-interactive files, instructions) used to generate an interactive file.

A data receiver 320 may comprise a file receiver 322, a manual entry receiver 324, and an entry facilitator 330, which may further comprise a GUI provider 332 and a customizable data database 334. A file receiver 322 may be configured similar or identical to the previously described file receiver 310, and may be similarly used to receive files, which may be directly or indirectly used (e.g. pre-processed) to generate an interactive media file. A manual entry facilitator 324 may facilitate a user in manually entering data (e.g. via keyboard text entry and/or sketching on a digital input pad). A manual entry facilitator may or may not utilize an entry facilitator 330, which may comprise and/or have access to customizable data for data selection and/or generation, and which may also have a GUI provider 332 to facilitate selection and/or modification of customizable data. For example, a user may select among different text overlays for an interactive file configured to overlay textual information on a displayed image. As another example, a GUI provider may illustrate a demonstration of the effect of the data on a separately provided file, and allow a user to graphically move overlay and/or annotation data within a viewing window of a display of a user device. The customizable data may comprise pre-determined content, location, and/or metadata for interaction with and/or modification of a non-interactive file provided to the file generation environment 300. For example, a user may replace default a default text annotation and/or overlay automatically or semi-automatically generated by the entry facilitator 330. Alternatively or additionally, the entry facilitator 330 and/or another component within or not within the file generation environment 300 may automatically or semi-automatically generate data (e.g. image segmentation boundaries and/or object labelling thereof) specific to a file (e.g. an image file).

A file generator may comprise a media file modifier 352, a media file compositor 354, a data embedder 356, a data transformer 358, a file decoder 360, a file encoder 362, a file encrypter 364 (which may further comprise a key generator 366), a file transmitter 368, a network communicator 370, and/or a third-party processor 372. A media file modifier 352 may be used to modify a provided file (e.g. a media file like an image), for example by modifying pixel values and/or generating information to provide to a media file compositor 354. A media file compositor 354 may utilize provided information and/or autonomously generate and/or composite media content to explicitly (e.g. via a new image file) and/or implicitly (e.g. via instructions used to process originally provided media content at a later time) different media content (e.g. an image with a modified color palette, or an video with “burned in” open captions). A data embedder 356 may embed (e.g. via concatenation, interleaving, and/or encrypting) provided data within a provided file and/or media file. A data transformer 358 may transform provided data (e.g. expound upon basic instructions and/or encode provided instructions in a data format more suitable for one or more computing devices) before, during, and/or after generation of a file, such as an interactive media file. A file decoder 360 may be used to decode a provided file and/or data. A file encoder 362 may be used to decode a provided file, provided data, and/or a generated interactive file before transmission of an interactive file. A file encrypter 364 may similarly transform the data format (e.g. for security, data privacy, and/or compatibility purposes) of a generated interactive file before transmission. A file encrypter 364 may comprise a key generator for transmission of a key with and/or alongside a generated interactive media file, and/or for later accessing of a key (e.g. from a server associating the key with an identifier of an interactive file). A file transmitter 368 may facilitate transmission of a generated file (e.g. an interactive media file), for example by establishing network communication with multiple different file hosting and/or presentation applications and/or servers (e.g. social media applications operating on user devices). A network communicator 370 may facilitate file transmission and/or communication with a third-party processor 372 (e.g. for payment processing, transaction verification). For example, a third-party processor 372 may be a financial processor and/or an electronic commerce (“ecommerce”) processor.

Generation of a file (e.g. an interactive file) may be facilitated by pre-formatted and/or pre-populated templates (e.g. from a customizable data database 334), a WYSIWYG (“what you see is what you get”) GUI editor (e.g. from a GUI provider 332), artificial intelligence (e.g. neural-network based semantic image segmentation, Mask R-CNN). Additionally or alternatively, the generation process and/or transmission of an interactive file may require at least one of a purchase, payment, author authentication, external permissions, etc. Maintenance (e.g. update and/or editing a generated and/or distributed interactive file) and/or logging (e.g. generating and/or storing an identifier and/or key associated with a generated interactive file) of data (such as an interactive file and related information) on a server may similarly require and/or be gated by at least one of a payment, author authentication, external permission, etc. Generate may generally refer to the process of creating new information directly (e.g. via explicit copying) and/or indirectly (e.g. via data transformation and/or access of external resources) from one or more provided files and/or data. Generating may also be referred to as transforming, modifying, combining, compositing, synthesizing, pumping, augmenting, interpreting, translating, reducing, and/or compressing. A generated interactive file may or may not display sensory indicia (e.g. an overlaid letter “P” in a corner indicating that the media content has been modified and/or contains interactive functionality) indicating interactivity, association with a specific interactive file generator and/or author, nature of the interactive content of the interactive file, and/or nature of the interactive functionality of the interactive file.

In some embodiments, a user may provide a non-interactive media file and other data to a file generation environment 300. For example, a user may provide a non-interactive photo or video (e.g. in a JPEG or MP4 format, respectively), and additionally provide a text file containing instructions for future execution in a derived interactive media file. In some embodiments, the user may provide the data to the interactive file generation environment by selecting among pre-determined options within the interactive file generation environment and/or customizing the pre-determined options. For example, after providing a non-interactive media file to the interactive file generation environment, the user may select a radio button within the interactive file generation environment specifying a type of instruction to be embedded within the interactive media file to be produced. For example, pre-determined instruction options may comprise overlaying data such as text, price, phone number, universal resource identifier (e.g. URL), image modification.

An interactive file generation environment 300 may be executed on a user device and/or on an external server. An interactive file generation environment 300 may comprise a user interface to facilitate user selection, upload, and/or modification (e.g. cropping, resizing, annotating) of a non-interactive media file. An interactive file generation environment 300 may comprise a similar user interface for selection and/or creation of data provided in addition to a non-interactive media file for generation of an interactive media file. An interactive file may have a limited lifetime, e.g. based on the number of days stored on a user device, relative to a pre-determined calendar date, and/or based on an expiration policy stored in a remote server polled during access of and/or interaction with the interactive media file. An “expired” interactive file may be inaccessible; unable to be displayed or output; overlaid with an obscuring image filter and/or textual indication; reduced to a non-interactive media file; reduced to non-interactive media content that the interactive file is based on (e.g. such that interactive data and/or functionality is “stripped out” and/or removed); inoperable to be interacted with; unable to access an external server to check for updates; unable to be edited in order to add, remove, and/or modify content; deleted; self-destructing; and/or corrupted.

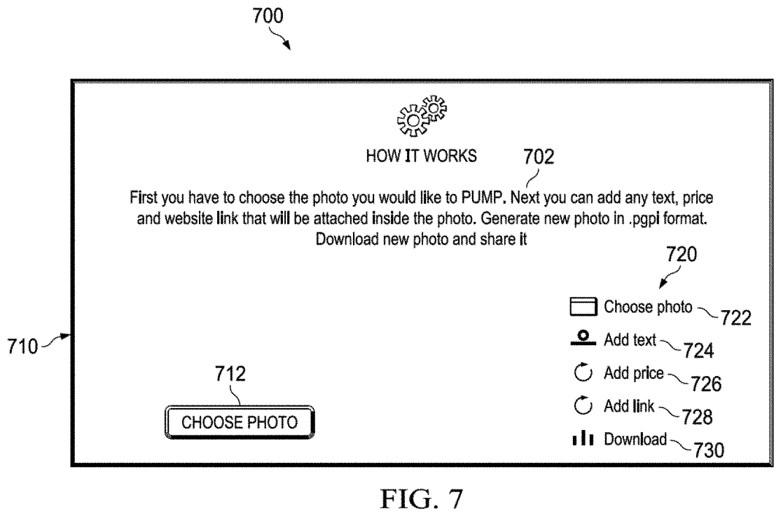

FIG. 7 illustrates an example embodiment of a GUI interface 700 of a file generation environment. The example GUI 700 comprises a window 710 bounding the user interaction area; informational and/or instructional text 702; a wallahrough sequence 720, comprising a photo selection stage 722, text selection and/or addition stage 724, price selection and/or addition stage 726, link selection and/or addition stage 728, and a download stage 730; and at least one user interaction element 712, such as a button.

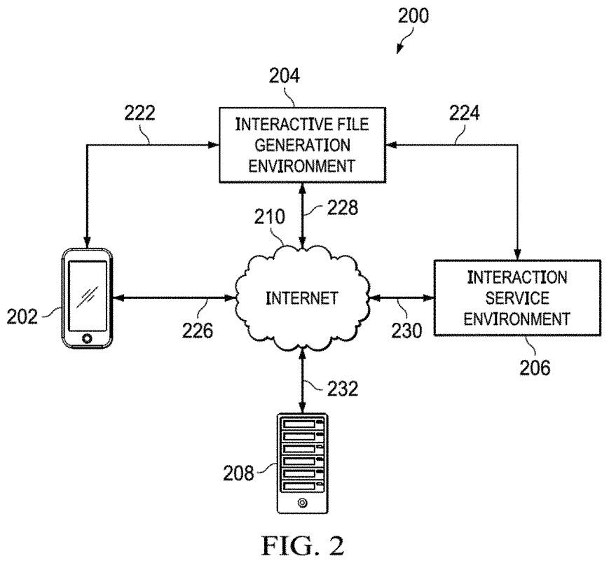

FIG. 2 illustrates an example embodiment of a network 200 facilitating generation, transmission, interaction with, and/or modification of an interactive file, such as an interactive media file. A network 200 may comprise an interactive file generation environment 204, a user device 202, an internet and/or the internet 210, an interaction service environment 206, and/or a user application server 208. An interactive file generation environment 204, user device 202, interaction service environment 206, and/or user application server 208 may or may not comprise a processor such as a CPU, GPU, ASIC, FPGA, CPLD, PLD, microcontroller, and/or microprocessor. Bi-directional communication links 222, 224, 226, 228, 230, 232 may connect components of the network 200. Some, all, and/or none of the illustrated elements of a network 200 may be used, and/or used in combination with unillustrated elements.

An interactive file generation environment 204 may be used to generate an interactive file. The generated interactive file can be sent directly to a user device 202 and/or an interaction service environment 206 over respective communication links 222, 224. Alternatively or additionally, transmission of at least a portion of an interactive file may occur through the internet 210 via necessary communication links 228, 226, 230. For example a user may download a generated interactive file (e.g. to a local device) for transfer via USB Flash drive and/or email to a user device 202. As another example, a hardwired connection may facilitate a transmission of an interactive file. An additional copy or the only copy of a generated interactive file may also be sent to an interaction service environment 206 in order to provide updates for, allowing editing of, and provide source data for the interactive file. For example, upon generation of an interactive file, an identifier (e.g. a hash key) may be sent to a user device 202 in order to later access, locate, and/or retrieve the interactive file from an interaction service environment 206 and/or user application server 208.

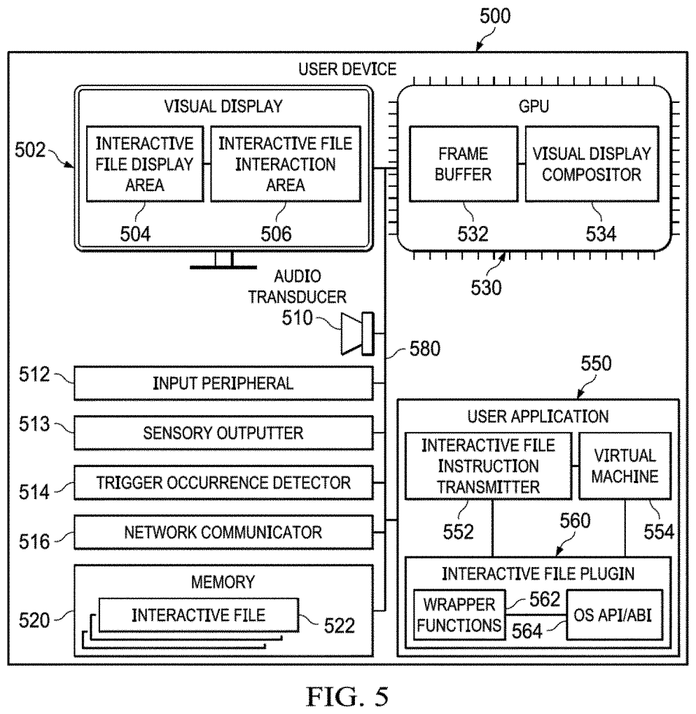

FIG. 5 illustrates a user device 500 for use in interacting with an interactive file. A user device 500 may comprise a visual display 502, an audio transducer 510, an input peripheral 512, sensory outputter 513, a trigger occurrence detector 514, a network communicator 516, memory 520, a GPU 530, and a user application 550 (e.g. a stored and/or running program). A visual display 502 may comprise an interactive file display area 504 and an interactive file interaction area 506. A visual display 502 may comprise a screen, touchscreen, monitor, LED display, projector, external screen, etc. For example, a visual display 502 may be a touchscreen of a user's smartphone, alternatively or additionally may be an external monitor connected to a processor (not shown in FIG. 5) of the user device 500. A user may interact with the display output of a visual display 502 via capacitive touch screen, mouse and keyboard, etc. A visual display may comprise an interactive file display area 504 operable and/or configured to visually display an interactive file, and the interactive file display area 504 may comprise a portion of the visual display 502 (e.g. an embedded photo within a social media application) or the entire screen (e.g. a full-screen viewing mode of an image viewing application). A user may interact with a displayed interactive file by using provided input peripherals 512 (e.g. touch screen, mouse) to perform an action which may or may not associated with a specific area of the visual display 502. For example a user could generically perform a mouse click or touch screen press anywhere on the visual display 502 (and/or operate another input not associated with the visual display 502) to initiate an interaction with an interactive file. Alternatively or additionally, a user could interact with a particular subset or portion of the visual display corresponding to an interactive file interaction area 506. An interactive file interaction area 506 may or may not correspond to the interactive file display area 504, and may or may not correspond to a specific object and/or segmentation of a display image. A user device 500 may comprise a smartphone, mobile device, headset, earbud, smart watch, display, tablet, remote server, augmented reality headset, virtual reality headset, and/or any other device operable and/or configured to be interacted with.

An interactive media file can alternative or additionally be output by using an audio transducer 510, or any sort of sensory outputter 513 (e.g. smell generator, taste generator, haptic feedback device). In other words, there are other sensory analogues for visual output (e.g. relating to sound, touch, taste, smell). For example, a tone or playing of a “default” audio file could be modified based on a user input. As another example, a vibration of a user device 500 could be modified based on a user input. Similarly, input peripherals 512 could also comprise analogues to visual input peripherals 512 (e.g. touchscreen, computer mouse), and such input peripherals 512 could be used in addition to or as an alternative to visual input peripherals 512. For example, an accelerometer or other motion sensing device (e.g. gyroscope, magnetometer, altimeter) could be used to detect a motion and/or gesture of a user device 500 itself or another device associated with the user device 500. Therefore, interaction may comprise shaking, swiping, sliding, voice commands, breath alcohol content, flower scent, roughness of object, physical properties of an object (e.g. magnetic moment, conductivity), etc.

A trigger occurrence detector 514 may be used to indicate to the user device 500 when a user has interacted with the user device (e.g. touch a specific portion of a displayed image within an interactive file interaction area 506), and/or whether another trigger event (e.g. automatic trigger after viewing an image for a certain period, or automatic trigger if viewing the image within a certain location, geo-location, altitude, and/or time period) has occurred.

A network communicator 516 may enable the user device to communicate with external computing devices, e.g. for update, verification, authentication, file access, file storage, and/or download purposes. Memory 520 of the user device may store zero or more interactive files 522, which may also be stored on and/or accessed from an external server and/or storage device communicable via the network communicator 516.

A graphics processing unit, or GPU 530, may be used to render, raster, and/or display media content within an interactive file display area 504. A GPU 530 may comprise a frame buffer 532 and/or a visual display compositor 534, e.g. for buffering and/or compositing a visual display of media content of an interactive file. The GPU 530 may also be provided instructions (e.g. by an interactive file 522) operable and/or configured to affect and/or modify the visual display of an interactive file. A GPU 530 may display media content comprising vectors graphics, bitmaps, rasters, overlays, and/or images of varying opacity and/or alpha value.

A user application 550 stored and/or running on a user device (either locally and/or remotely via an emulator) may facilitate display and/or user interaction with an interactive file. For example, a social media application may define an interactive file display area 504 operable and/or configured to display an interactive file. A user application may comprise an interactive file instruction transmitter 552, a virtual machine 554, and/or an interactive file plugin 560, which in turn may comprise wrapper functions 562 and/or an operating system (OS) API (application programming interface) and/or ABI (application binary interface) 564. An interactive file instruction transmitter 552 may transmit interactive file instructions to and/or from a computing device (e.g. processor) of the user device 500 from and/or to an interactive file. Alternatively or additionally, a virtual machine 554 may facilitate running and/or executing instructions of an interactive file within a user application 550 and/or user device 500. The interactive file instruction transmitter 552 and/or virtual machine 554 may use an interactive file plugin 560 (e.g. the wrapper functions 562 or API 564 thereof) in order to relay and/or translate instructions in one computer language format to another computer language format that may better facilitate execution of one or more instructions encoded in the second computer language format on a computing device (e.g. CPU). A user application may be a social media application, a photo sharing application, a cloud storage application, a photo editing application, a video game application, an operating system, a kernel, a driver, and/or any other application that may be used by a user on a user device 500.

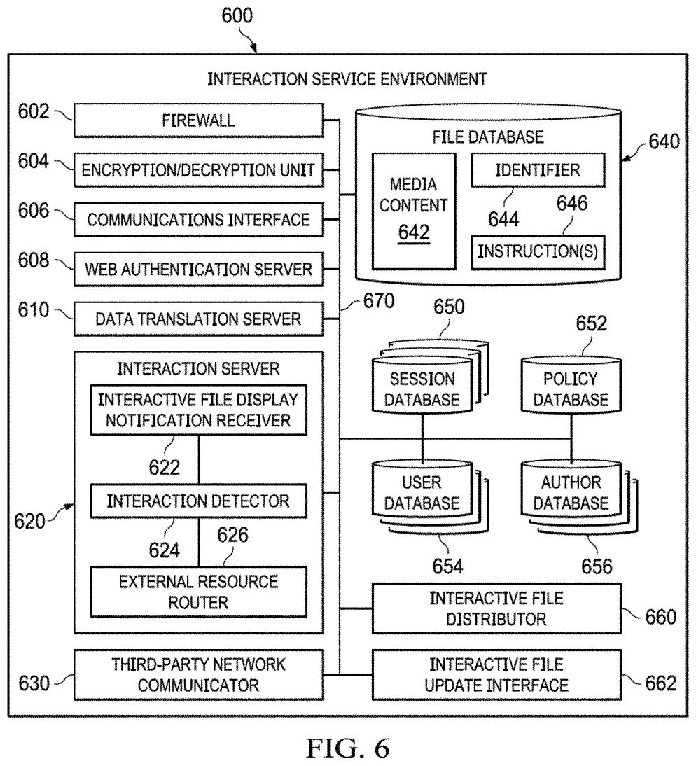

FIG. 6 illustrates an interaction service environment 600, which may comprise a firewall 602, encryption/decryption unit 604, communications interface 606, web authentication server 608, data translation server 610, interaction server 620, third-party network communicator 630, file database 640, session database 650, policy database 652, user database 654, author database 656, interactive file distributor 660, interactive file update interface 662, and/or inter-connecting communication bus 670 (e.g. which may be wired, locally networked, remotely networked, and/or wireless).

A firewall 602, encryption/decryption unit 604, communications interface 606, web authentication server 608, and/or data translation server 610, may be used to communicate with external computing devices (e.g. over a network such as the internet), verify security of communications and/or communicated date, and/or appropriately translate data formats.

An interaction service 620 may directly and/or indirectly communicate with a user device outputting an interactive file (e.g. displaying an image on a visual display) in order to perform backend functions before, during, and/or after user interaction. An interactive file display notification receiver 622 may detect when an interactive file has been output and/or requested to be display on a user device. This may prompt the interaction server 620 to send updated information concerning the interactive file, authentication information, security information, etc. An interaction detector 624 may detect when a user or other triggering event has initiated interaction with an interactive file (e.g. upon click by a user). This may similarly prompt the interaction server 620 to send updated information concerning the interactive file, authentication information, security information, etc. Additionally or alternatively, the interaction server 620 and/or interaction service environment 600 may send real-time information to a user device upon user interaction with an interactive file (for example, a user may request a search of a displayed item, and/or request purchase of a displayed item). An external resource router 626 may be used to communicate with external resources (e.g. search information database, payment processor) in order to facilitate such user interactions with an interactive file. A third-party network communicator 630 may similarly be used to interact with external resources in order to send, receive, and/or transform data before, during, and/or after user interaction with an interactive file. For example, a third-party network communicator 630 may comprise a communicator to a payment processor, and/or comprise an interface operable and/or configured to interact with a social media server and/or information database.

A file database 640 may comprise copies of at least a portion of interactive files. The file database 640 may therefore comprise media content 642, one or more instructions 646, and/or identifiers 644. The file database 640 may serve as a backup of interactive files in case interactive files stored on user devices are lost, corrupted, deleted, and/or never transmitted to a user device. Additionally or alternatively, a file database 640 may serve as a “ground truth” for how up-to-date interactive files are, and therefore may be referenced, checked, and/or compared against before, during, and/or after an interactive file is displayed, outputted, and/or interacted with on a user device. One or more identifiers 644 associated with one or more interactive files (though not necessarily in a bijective, one-to-one relationship) may be used for condensed and/or robust identification of a specific interactive files and/or sets of interactive files by a user device, interaction server 620, and/or interaction service environment 600.

An interaction service environment may further comprise session databases 650 (e.g. for storing and/or monitoring user interaction sequences with one or more interactive files for security, fraud, abuse, marketing, and/or statistical purposes), a policy database 652 (e.g. for defining a policy regarding interactive file update frequencies, interactive file content allowances, interactive file editing procedures, and/or interactive file authentication procedures), user databases 654 (e.g. for storing information on one or more users for user convenience purposes, user history storage, and/or purposes similar to those for session databases 650), and/or author databases 656 (e.g. for storing information for purposes similar to those for user databases 654). For example, a user profile stored in a user database 654 may comprise payment (e.g. credit card) information, activity history, and interaction rates. An interactive file author profile stored on an author database 656 may store links to other interactive files by the same author, author rating, and/or factors that may affect author posting approval (e.g. record of fraudulent transactions).

An interactive service environment 600 may further comprise an interactive file distributor 660 (e.g. for distributing interactive files upon generation and/or at regular intervals to various user devices and/or user application accounts) and/or an interactive file update interface 662 (e.g. for updating and/or editing interactive files).

An interactive file may comprise one or more executable instructions, which may comprise one or more functions, services, handlers, and/or listeners. An interactive file may also comprise one or more execution engines. An execution engine may load, verify, execute, prioritize execution of, define memory area for, and/or specify file format of an executable instruction. Further, an execution engine may comprise a file format, register set, garbage collection parameters, error reporter, exception handler, libraries, environment variables, metadata, directory structure, runtime system, runtime environment, and/or other processing functionality operable and/or configured to dynamically determine behavior of one or more instructions of an interactive file during execution. An execution engine may perform real-time conversions of an instruction from a first data format to a second data format. That is, an execution engine may or may not translate an instruction to a different computer language format (e.g. as defined by a compiler and/or interpreter). For example, an execution engine may comprise wrapper functions that convert interactive file instructions in a general, standardized format to a device and/or software specific format in order to facilitate execution by a user device. An execution may convert an instruction to a higher-level, lower-level, and or same-level data format, as recognized by software in the hierarchy of a software stack operating on a user device and/or remote server. Alternatively or additionally, an execution engine may control (e.g. via memory area definition) and/or analyze (e.g. via garbage collector operation) execution of one or more instructions of the interactive file.

An execution engine may comprise an interpreter, bytecode interpreter, translator, compiler, just-in-time compiler, cross-compiler, external interface, event handler, error reporter, virtual machine, virtual processor, hypervisor, emulator (e.g. over the network like xterm), virtual process, virtual system, process, plugin, thread, and/or sandboxed environment. An execution engine may interact with an application, operating system, sandboxed environment, communication interface, kernel, driver, assembler, and/or computer hardware. In some embodiments, an execution engine may be installed on a user device. In some embodiments, an execution engine may not be installed on a user device, and/or may check for a pre-existing execution engine installation before installation and/or execution. An execution engine may serve as a platform (i.e. standardized hardware, firmware, and/or software interface) for instructions of a standardized data format, or may use and/or rely on a software and/or hardware platform provided by a user device. At least a portion of a program of an interactive file may be pre-loaded into memory and/or loaded upon a trigger event.

An interactive file may comprise all the instructions necessary to be run on a user device, or may rely on additional execution facilitation and/or functionality in addition to the instructions and/or execution engine provided by the interactive file. An interactive file may load software objects at runtime (e.g. library, content, interpreter, compiler). An interactive file could be partially or entirely facilitated by a plugin, by the viewer application, by a standalone application running on the OS directly and interacting/cooperating with the application, and/or by a virtual machine running within any of the aforementioned. Additionally or alternatively, an interactive file may be executed partially or entirely on a remote computing device via an emulator (e.g. xterm). If an interactive file carries out instructions on a user device via a user application, the user application may pass commands to the operating system of the user device, implement its own interpreter and/or wrapper functions for self-executable code, implement its own compiler and/or language translator, and/or pass through commands to an application programming interface (API) and/or application binary interface (ABI) (e.g. of an operating system). An interactive file may also be self-executable, such that it does not rely (at least entirely) on external software and/or hardware resources). For example, a self-executable interactive file can directly modify its visual display through communication with device drivers and/or hardware, and/or through communication with a higher-level programming interface. As another example, a user application may directly send the self-executable program to the user device OS, and then give control of the display and interaction of the execution viewport to the OS. A self-executable interactive file may use a library, such as a static library routines (e.g. such that functionality may be embedded within media content of the interactive file) and/or dynamic library routines (e.g. such that functionality may be called from the computing device, from pre-existing files, from “sidecar” files transmitted with the interactive file, and/or through the internet.

The sensory output (e.g. visual display, aural transduction) of the interactive media file in a default, pre-triggered state may or may not comprise sensory indicia (e.g. visual icon, aural modulation) indicating that the interactive media file is interactive and/or contains at least one instruction. If the sensory output of the interactive media file in a default, pre-triggered state comprises sensory indicia, the sensory indicia may indicate the type, number, extent, etc. of the interactive features and/or at least one instruction.

The user may access media file-associated data not visually displayed by default by interacting with the media file. For example, the user may click (or press) on the visual display of the media file or a programmatically-designated region of the device display. There may be multiple levels of interaction with the viewport, such that a user can click through and/or configure the visual display within the viewport. Further, an option may be presented to “go back” to a previous visual display within the viewport. Beyond manually clicking and/or touching, interaction with a media file may occur automatically, e.g. based on location information (e.g. geo-fencing), scrolling information (e.g. activated upon display to user), user attributes (e.g. user birthday), or user actions not directly related to the media file (e.g. user access of a website). “Automatic” accessing of the metadata programs within an interactive file may be enabled, e.g. if the user accepts privacy policy and allowed the file to access his location for example. Depending on the location of the embedded data (i.e. locally within the file, or indirection to a remote server), the system may display the data by accessing a local copy of the metadata and/or computer program upon media file interaction, or by requesting the information from a remote server.

Sensory output may be updated upon a trigger event. Upon occurrence and/or detection of a trigger event, the modification of the sensory output of an interactive file may or may not be facilitated by an external application, server, network communication, authentication procedure, update verification procedure, wrapper function, static library, dynamic library, interpreter, compiler, operating system, kernel, hardware driver, etc. That is, the modification of the sensory output may occur autonomously or with assistance from external resources. An instruction of the interactive media file may interact with and/or instruct at least one external resource according to the initial configuration of the interactive media, according to information from the trigger event (e.g. time delay between default sensory output of interactive media file and detection of trigger event, type of trigger event), and/or according to post-creation information provided by an external server (e.g. interaction server provides mask or gating condition on execution of instruction based on interaction period expiration, and/or other information).

The region of a computing device screen or monitor displaying a media file may be referred to as a viewport. In other words, the viewport may include all the device screen pixels displaying a media file. The viewport is generally a spatially contiguous set of pixels representing the displayed media file, but the viewport may or may not comprise a well-defined shape (e.g. polygon). Further, the viewport boundary may or may not comprise pixels with partial opacity, i.e. pixels who both display the media file and another visual object (e.g. background wallpaper). A viewport may also be referred to as a display area, logical screen, display mask, and/or viewing window.

In some embodiments the viewport may correspond to a screen and/or display of a user device, such as the interactive file display area 504 of the user device 500 of FIG. 5. In some embodiments, visual display and/or display may refer more generically to any kind of sensory output (e.g. audio, video, taste, smell), and therefore may refer to other output devices, such as the audio transducer 510 of FIG. 5.

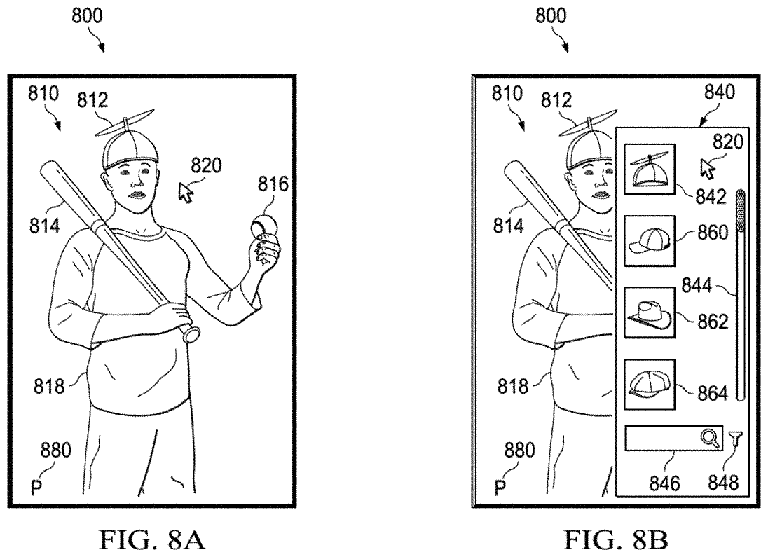

FIGS. 8A and 8B illustrate an example embodiment of an application of an interactive file. A viewport and/or interactive file display area 800 may display an image. An image may comprise a person 810 and/or objects 812, 814, 816, 818. A person 810 and/or object 812, 814, 816, 818 may be selectable by a user via a touchscreen or clicking on a person and/or object with a mouse cursor 820. A graphical and/or visual indicator 880 (e.g. a “P”, which may indicate interactive file format) that the displayed and/or outputted media content is interactive may also be present. A visual indicator 880 may or may not be used to indicate (e.g. to a user) that a file supports interactivity, is of a certain file type, contains a certain type of content, and/or supports a certain type of interactivity.

Once a trigger event occurs, such as a user click action, the displayed interactive file may transition from a first display state (e.g. a “default” and/or un-triggered image display state, corresponding to FIG. 8A) to a second display state (e.g. a “modified” and/or triggered image display state, corresponding to FIG. 8B). For example, a second display state may graphically present further interaction options to a user within an interaction window 840. In this example, after a user clicks on a hat object 812 worn by a person 810 in the displayed media content of the interactive file, a search box 840 is presented, which may search for hats generally, similar hats, hats in the same price range, hats nearby, hats of the same color, etc. Searched hats 842, 860, 862, 864 may be displayed and scrolled through via an interaction element 844, such a scroll bar. Additional search functionality may be provided, such as a textual search bar 846 and/or a search filter 848.

Persons 810 and/or objects 812, 814, 816, 818 may be pre-segmented by pixels within an interactive image (e.g. based on original generation of the interactive file), and/or segmented upon user interaction with an interactive image (e.g. performed by instructions and/or algorithms within or not within the interactive file, before or during display of the interactive image). In the example of a segmented image, segmented regions may be manually defined by a user and/or automatically defined based on a local or remote algorithm. Image segmentation algorithms are well known in the art of processing images.

Other applications of an interactive file may comprise financial transactions, data providing (e.g. search results, textual annotations), visual output modification, recursive interactive file interactions (e.g. open an interactive file from within an interactive file), search (e.g. visual, textual, location-based), links to external sites, rendering external site code (e.g. HTML, CSS, and/or JS), ticket booking, language selection and/or translation, displaying and/or identifying object characteristics (e.g. of objects visually displayed by image media content), media file modification (e.g. image filter, paint application), and/or location geo-location services.

An interactive file may be used for blockchain, may be facilitated by blockchain, and/or may operate on a blockchain network (or any kind of cryptographic transaction and/or distributed ledger network). An interactive file may be to view and/or purchase real estate (e.g. to visualize exteriors and/or interiors of homes), to conduct conference calls (e.g. click on displayed person to get email address and/or other information), to place a call, to perform electronic commerce, to perform messenger functionality, to serve advertisements, to interact with advertisements, to develop drugs (e.g. pharmaceutical compounds), to interact with books (e.g. e-books), to view construction plans, to visualize interior decoration arrangements, to design architecture models and/or interior designs, and/or to perform delivery services (e.g. for food, flowers). Interactive files may also be used for social messengers, social media, gaming, holograms, display content within web pages (e.g. via i-frames), education (e.g. visualization of anatomy, interaction with historical timelines), and/or facilitate transportation services.

In some embodiments, interactive files may involve installation, allocation, directives, implementation languages, command lines, configuration files, versioning, testing, frameworks, states, builds, responsive features, operational features, components, deployment, containers, and/or containerization. In some embodiments, an interactive file may comprise the file format of a non-interactive file (e.g. JPEG), and may further include data, metadata, and/or instructions operable to be executed by software different than the software used for the non-interactive file format (e.g. an image viewer application).

Interactive files may be operable and/or configured to be updatable and/or editable. For example, an interactive file may be edited in a file generation environment by providing the interactive file as a “non-interactive file”. An interactive file may also store historical interactions and/or transmit interactions to/from a local or remote computing device. An interactive file may be updated “in the field”, e.g. on a user device via an application for updating interactive files, and/or within the original viewing environment used for interacting with interactive files. Interactive files may be “crowd sourced” by allowing more than one user to create and/or modify an interactive file. The updating and/or editing of interactive files may also take place directly and/or indirectly through a remote server, e.g. a server that is used to store copies of and/or serve an interactive file. Editing may also be referred to as supplementing, complementing, adding, removing, deleting, mixing, overlaying, and/or adjusting.

Data may be edited, e.g. if there is a connection to internet upon interaction, if an interactive file automatically checks whether there is update of metadata on a server side (e.g. the file stores the last updated timestamp and if the last updated timestamp on the server side is different, new metadata is downloaded onto file). The process of updating may comprise rewriting metadata from a server. In some embodiments, there may be a lifecycle of stored metadata inside an interactive file if an internet connection is not provided and/or does not exist (e.g. if the automatic check has not been performed for more than one week, an interactive file may not work and will request an internet connection).

Benefits of the disclosed interactive file generation and interaction system and method may include a reduced number of times required to create interactive media content for various applications and/or software platforms, flexibility of the interactive content that may be provided, and local storage of media file content and/or instructions.

By creating an interactive media file containing executable instructions and an execution engine operable (and possibly configured) to execute those instructions, the interactive media file creator may not need to redundantly create interactive media files specific to each software application and/or platform on which the creator wishes to distribute the interactive media file. For example, different software applications may provide different file format protocols and/or in-app file annotations processes for generating interactive media files specific to that application. In contrast, the disclosed interactive media file generation and transmission process may enable a “build once, run everywhere” development flow, which in addition to potentially reducing the amount of time to broadly distribute content, may also prevent errors and/or inconsistencies among interactive media files developed specifically for different software applications and/or platforms.

The disclosed interactive media file generation process may also provide increased flexibility on the types of interactive content and interaction mechanisms provided with media files. For example, as discussed previously, a user may perform a search within the display area of the interactive media file, e.g. as opposed to performing the search within a different application. In fact, the range of functionality may obviate the need of an external website, as the functionality of external websites may be encompassed within and/or by the interactive media files (e.g. in the case of a retail website that may provide all merchandise viewing and purchasing in association with one or more interactive media files). For example, a user may be able to purchase an airline ticket within an interactive media file by clicking through menus within the display area of the interactive media file as opposed to a traditional airline website. Additionally, the disclosed interactive media file may enable various types of functionality specific to the media content. For example, image content provided may be segmented (e.g. based on software instructions provided with the interactive media file and/or based on external software algorithms invoked by the interactive media file) in order to perform an operation (e.g. search, product identification, price identification, vendor identification) of a subset of the display area of the interactive media file.

An interactive media file as disclosed herein may also be advantageous due to a local storage of media file content and/or instructions operable to modify the output of the interactive media file upon interaction. For example, in case of a user not having access to the internet (e.g. if a user is in a low signal reception area such as a tunnel or within a building), the information used to output, define interaction with, and/or modify the interactive media file may be stored locally such that the user can still perform the interactive functions. Further, as discussed previously, an interactive media file and/or a supporting software application may perform a verification and/or update check on the interactive media file content in order to ensure that the content is not “stale” or contains “dead” external links (e.g. a website URL).

In some embodiments, the described system and/or method may require user consent and/or acceptance before downloading, running, executing, and/or allowing interaction with an interactive file. For instance, there may be security concerns from the perspective of the user, user device, application, and/or third-party network, which may require encryption, GDPR compliance, authentication, monitoring metadata tagging (e.g. for tracking purposes), separate cloud processing, etc., in order to operate the described system and/or carry out the described method. In some embodiments, an approved hardware and/or software plugin may be required to execute some or all of an interactive file (e.g. instruction(s), execution engine, execution enabler).

In some embodiments, the described system and/or method may account for the file size of a non-interactive file size, data size, an interactive file size, and/or media content. For example, compression algorithms as are well known in the art may be used to reduce file size in a lossy or losslessly manner Additionally or alternatively, some or all information associated with a non-interactive file, data, interactive file, and/or media content may be stored remotely and transmitted as needed, and/or be generated as needed.

While various implementations in accordance with the disclosed principles have been described above, it should be understood that they have been presented by way of example only, and are not limiting. Thus, the breadth and scope of the implementations should not be limited by any of the above-described exemplary implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages. A non-transitory computer readable medium may comprise code configured to perform any of the methods described herein. A non-transitory computer readable medium may comprise computer memory and/or computer memory may comprise a non-transitory computer readable medium. Any computing device or system described herein may comprise memory and/or a non-transitory computer readable medium. Any component of any system may be combined with any component of any other system (and/or the same system). Any step of any method and/or process may be combined with any other step (or a same step) of any other (or same) method and/or process. Any system operable to realize a described method or process could be used. A described system could be configured to carry out any method, step, and/or procedure which the system is operable to carry out. Data may be transmitted in any configuration among a server, user, application, device, file, interactive file, internet, and/or file generation environment.

Various terms used herein have special meanings within the present technical field. Whether a particular term should be construed as such a “term of art,” depends on the context in which that term is used. “Connected to,” “in communication with,” “communicably linked to,” “in communicable range of” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, any section headings provided herein are for consistency with the suggestions under 37 C.F.R. 1.77 or otherwise to provide organizational cues. These headings shall not limit or characterize the implementations set out in any claims that may issue from this disclosure. Specifically and by way of example, although the headings may refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings herein.

Additionally, although similar reference numbers may be used to refer to similar elements for convenience, it can be appreciated that each of the various example implementations may be considered distinct variations.

Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Where open terms such as “having” or “comprising” are used, one of ordinary skill in the art having the benefit of the instant disclosure will appreciate that the disclosed features or steps optionally may be combined with additional features or steps. Such option may not be exercised and, indeed, in some embodiments, disclosed systems, compositions, apparatuses, and/or methods may exclude any other features or steps beyond those disclosed herein. Elements, devices, methods, and method steps not recited may be included or excluded as desired or required. Persons skilled in the art may make various changes in methods of preparing and using a device and/or system of the disclosure.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value+/−about 10%, depicted value+/−about 50%, depicted value+/−about 100%) and/or a range endpoint. With respect to the former, a value of 50 depicted in an example, table, and/or drawing may form the basis of a range of, for example, about 45 to about 55, about 25 to about 100, and/or about 0 to about 100. Disclosed percentages are weight percentages except where indicated otherwise.

It will be understood that particular embodiments described herein are shown by way of illustration and not as limitations of the disclosure. The principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

The title, abstract, background, and headings are provided in compliance with regulations and/or for the convenience of the reader. They include no admissions as to the scope and content of prior art and no limitations applicable to all disclosed embodiments.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this disclosure include preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

1. A method comprising:
receiving, using one or more computing device processors, a non-interactive media file encoded in a first file format;
receiving, using the one or more computing device processors, first data;
generating, using the one or more computing device processors, based on the non-interactive media file and the first data, an interactive media file comprising:
one or more executable instructions based on the first data, and
an execution engine for enabling a user device to execute the one or more executable instructions;
wherein the interactive media file is encoded in a second file format; and
transmitting, using the one or more computing device processors, the interactive media file to the user device,
wherein the user device displays the interactive media file within a display area of the user device or a display associated with the user device,
wherein an occurrence of a trigger event causes execution, by a processor, of at least one executable instruction of the one or more executable instructions of the interactive media file,
wherein the processor uses the execution engine for executing the at least one executable instruction of the one or more executable instructions of the interactive media file, and
wherein the execution, by the processor, of the at least one executable instruction of the one or more executable instructions, causes a display state of the interactive media file to be modified, within the display area of the user device or the display associated with the user device, from a first display state to a second display state,
wherein the one or more executable instructions, based on the first data and comprised in the interactive media file transmitted to the user device, are updated, after transmission of the interactive media file to the user device, at the user device, based on a communication between the user device and a remote server and based on an update policy verifier and an interactive media file identifier associated with the interactive media file.

2. The method of claim 1, wherein the execution engine comprises an application.

3. The method of claim 1, wherein the execution engine comprises data providing instructions for executing the at least one executable instruction of the one or more executable instructions.

4. The method of claim 3, wherein the at least one executable instruction of the one or more executable instructions is executed by an application on the user device.

5. The method of claim 1, wherein the execution engine comprises metadata, and wherein the processor is located either in the user device or remotely from the user device.

6. The method of claim 1, wherein the user device comprises at least one of a desktop computer, a mobile computing device, a mobile phone, a tablet computing device, a watch, a wearable device, a motor vehicle, eyewear, or a headset.

7. The method of claim 1, further comprising sharing the interactive media file on at least one of a social media platform, an electronic commerce platform, a messaging platform, or a video-based platform.

8. The method of claim 1, wherein the modification of the display state of the interactive media file is based on data received from an interaction server associated with a third-party network.

9. The method of claim 1, wherein the one or more executable instructions, based on the first data and comprised in the interactive media file transmitted to the user device, are updated in substantially real-time upon determining an interaction, on the user device, with the interactive media file.

10. The method of claim 1, wherein the non-interactive media file comprises at least one of a photo, a video, an audio, a substantially real-time media stream, text, or data.

11. The method of claim 1, wherein the interactive media file comprises a partially self-executing interactive media file.

12. The method of claim 1, wherein the second file format is different from the first file format.

13. The method of claim 1, wherein the second file format is the same as the first file format.

14. The method of claim 1, wherein the user device verifies, based on interaction with the remote server, that the interactive media file is an updated version of the interactive media file before execution of the at least one executable instruction of the one or more executable instructions.

15. The method of claim 1, wherein the display state of the interactive media file is modified, within the display area of the user device or the display associated with the user device, from the first display state to the second display state, when the user device is not connected to a network or the Internet.

16. The method of claim 1, where contents or a source associated with the first data is based on the non-interactive media file.

17. A system comprising:
one or more computing device processors configured to:
receive a non-interactive media file encoded in a first file format
receive first data; and
generate an interactive media file based on the non-interactive media file and the first data, wherein the interactive media file is encoded in a second file format, and wherein the interactive media file comprises:
one or more executable instructions based on the first data, and
an execution engine for enabling a user device to execute the one or more executable instructions; and
transmit the interactive media file to a user device;
wherein the user device is configured to display the interactive media file within a display area of the user device or a display associated with the user device,
wherein an occurrence of a trigger event causes execution, by a processor, of at least one executable instruction of the one or more executable instructions of the interactive media file,
wherein the processor uses the execution engine for executing the at least one executable instruction of the one or more executable instructions of the interactive media file, and
wherein the execution, by the processor, of the at least one executable instruction of the one or more executable instructions, causes a display state of the interactive media file to be modified, within the display area of the user device or the display associated with the user device, from a first display state to a second display state,
wherein the one or more executable instructions, based on the first data and comprised in the interactive media file transmitted to the user device, are updated, after transmission of the interactive media file to the user device, based on a communication between the user device and a remote server and based on an update policy verifier and an interactive media file identifier associated with the interactive media file.

18. The system of claim 17, wherein the interactive media file further comprises a segmented image.

19. The system of claim 18, wherein the interactive media file further comprises data configured to associate one or more portions of the display area of the user device or the display associated with the user device, or the at least one executable instruction of the one or more executable instructions, with one or more segmented regions of the segmented image.

20. The system of claim 17, wherein the trigger event is configured to occur automatically based on a programmed condition.
